(19) United States
(12) Patent Application Publication
(10) Pub. No.: US 2010/0133071 A1
(43) Pub. Date: Jun. 3, 2010

(54) TRANSFER BELT

(76) Inventors: Matthias Schmitt, Munchen (DE); Klaus Hermann, Giengen (DE); Kjell Anders Karlsson, Orebro (SE)

Correspondence Address: Todd T. Taylor;Taylor & Aust, P.C., 142 S. Main Street, P.O. Box 560, Avilla, IN, 46710, US

(21) Appl. No.: 12/606,576

(22) Filed: Oct. 27, 2009

Related U.S. Application Data
(63) Continuation of application No. PCT/EP2008/052472, filed on Feb. 29, 2008.

(30) Foreign Application Priority Data
Apr. 27, 2007 (DE) 10 2007 019 960.2

(51) Int. Cl. B65G 15/34

(52) U.S. Cl. 198/847

(57) ABSTRACT

A transfer belt for carrying a fibrous web and a papermaking or similar machine. The transfer belt consists of a supporting substrate of a polymer foam and a reinforcement layer of aramid or glass fiber in either fabric or layer foam and a release layer that overlies and is bonded to the supporting substrate. The release layer is formed from a material promoting release of the fibrous web. The release layer may be selected from a variety of materials. The layers each contribute their own function to the operation of the belt to provide superior performance.

### CROSS REFERENCE TO RELATED APPLICATIONS

This is a continuation of PCT application No. PCT/EP2008/052472, entitled “TRANSFER BELT”, filed Feb. 29, 2008, which is incorporated herein by reference.

### BACKGROUND OF THE INVENTION

1. Field of the Invention

The present invention relates to a belt suitable for use in papermaking in papermaking process, and, more particularly, to a belt that transfers fibrous material from one station to another.

2. Description of the Related Art

In recent years, the “closed draw” papermaking machine has been developed for achieving higher speed operation of a papermaking machine. In contrast with the conventional open draw machine, in which a wet fibrous web is transferred without being supported, in the closed draw machine, the wet fibrous web is supported throughout the papermaking process. The closed draw structure solves various problems encountered in the operation of the open draw machines, such as running out of paper. In addition, the open draw machines are susceptible to fibrous web breakage when the web is in an unsupported state. The closed draw papermaking machine thus enables higher speed production.

There are several requirements for the proper operation of the wet fibrous web transfer belt. For transfer, the wet fibrous web must be attached to the transfer belt, during transport, after the belt moves out of the press part or preceding process station. However, the wet fibrous web must be removable from the transfer belt smoothly when the web is transferred to the next stage of the papermaking process. An essential problem is that it is difficult to detach the fibrous web from this kind of known surface structure, particularly when the fibrous web is still wet.

Current transfer belt designs usually consist of a substrate of press felt or woven fabric needled with fibrous batt with an impermeable layer to carry the fibrous web. The combination of the substrate and the impermeable web carrying layer is strong enough to survive paper machine conditions under industrial duty cycles. The result of this structure, however, is that the paper carrying layer, which is impermeable, has an essential function for the stability of the belt.

The disadvantages of this type of construction are the compromises in the material and the properties of the two layers. For example, the impermeable layer should have wear resistance but provide good resilience and release properties. These characteristics are at odds with one another.

Therefore, there exists a need in the art to provide a transfer belt that has improved stability and at the same time has good resilience and release properties.

### SUMMARY OF THE INVENTION

The invention, in one form, is directed to a transfer belt for carrying a fibrous web in a papermaking or a similar machine having a supporting substrate of polymer foam for providing wear resistance and resilience and a reinforcement layer selected from the group consisting of aramid and glass fiber in one of a fabric and layer form. A release layer overlies and is bonded to the supporting substrate, the release layer being formed from a material promoting release of the fibrous web from the transfer belt.

An advantage of the present invention is the separation of the functional characteristics of the layers in a belt so that each layer provides optimum performance.

### BRIEF DESCRIPTION OF THE DRAWINGS

The above-mentioned and other features and advantages of this invention, and the manner of attaining them, will become more apparent and the invention will be better understood by reference to the following description of an embodiment of the invention taken in conjunction with the accompanying drawing, wherein:

FIG. 1 is an enlarged cross-section view of a transfer belt embodying the present invention.

Corresponding reference characters indicate corresponding parts throughout the several views. The exemplification set out herein illustrates one embodiment of the invention and such exemplification is not to be construed as limiting the scope of the invention in any manner.

### DETAILED DESCRIPTION OF THE INVENTION

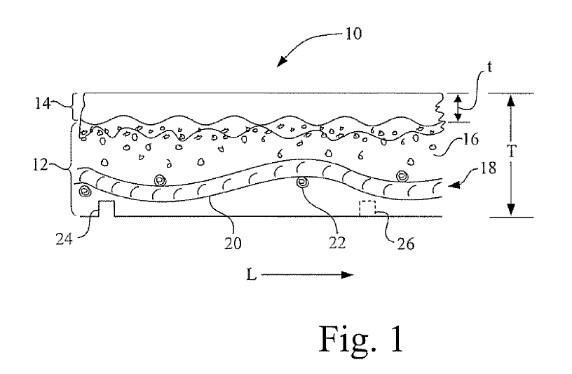

FIG. 1 illustrates a transfer belt 10 including a substrate, generally indicated by reference character 12, and a release layer, generally indicated by reference character 14. Substrate 12 includes polymer foam 16 and a reinforcement layer 18. Reinforcement layer 18 can be formed from aramid or glass fiber either in a fabric or in a layer form.

The release layer 14 overlies, is bonded to the supporting substrate 12 and, preferably penetrates substrate 12 to form an intimate interconnection. In order for the release layer 14 to be effective in releasing a fibrous web it is formed from a material that promotes release of the fibrous web.

A wide variety of materials may be employed for the release layer. Each of the materials acts to promote release of the fibrous web, but in using different mechanisms. Examples of materials may be silicones, fluorinated polymers, polyolefin's, thermoplastic elastomer (TPE), thermoplastic urethane (TPU), plasma and/or corona treated polymers, waxes, materials exhibiting the “Lotus Effect”, micro and/or nano structured layers and oil covered layers.

Silicones, or polysiloxanes, are inorganic-organic polymers with the chemical formula [R2SiO]n, where R=organic groups such as methyl, ethyl, and phenyl. These materials consist of an inorganic silicon-oxygen backbone (. . . —Si—O—Si—O—Si—O—. . .) with organic side groups attached to the silicon atoms, which are four-coordinate. In some cases organic side groups can be used to link two or more of these —Si-O— backbones together. By varying the —Si—O— chain lengths, side groups, and crosslinking, silicones can be synthesized with a wide variety of properties and compositions. They can vary in consistency from liquid to gel to rubber to hard plastic. The most common type is linear polydimethylsiloxane or PDMS. The second largest group of silicone materials is based on silicone resins, which are formed by branched and cage-like oligosiloxanes.

Fluorinated polymers posses a property of having very low surface energy. One example of such a fluorolpolymer is Teflon. Flourinated polymers permit the easy removal of material from their surface and, as such, are suitable for the release layer 14.

A polyolefin is a polymer produced from a simple olefin or alkene as a monomer. An example of a polyolefin suitable for the release layer is polypropylene which also has the ability to allow material to be removed from its surface.

A thermoplastic elastomer is a copolymer which consists of a thermoplastic and an elastomer. Most elastomers are thermosets and are easy to use in manufacturing. This is a class of material that shows both advantages typical of rubber materials and plastic materials in terms of mechanic-elastic properties. Again, they have the ability to allow surface material to be easily removed.

Thermoplastic urethane (TPU) elastomers combine high elongation and high tensile strength to form tough elastomers. Aromatic polyether TPU's can have excellent flexibility life and tensile strength exceeding 500 psi and ultimate elongations greater than 700%. As such, the TPU is also a suitable material for the release layer 14.

Another approach is to plasma and/or corona treated polymers to treat the surface to improve the ability to remove material from the release layer 14.

Further approaches may be to apply waxes or oil covered layers. The material may be in micro and/or nano structured layers all of which promote easy release of material from the release layer 14.

Another approach is to provide materials that exhibit, or are treated to exhibit, the “Lotus Effect” which emulates the self-cleaning property found in Lotus plants. This can be achieved by treatment of the surface of material with a fluorochemical or silicone treatment. It is also possible to achieve such affects by using combinations of polyethelyene glycol with glucose and sucrose.

All of the above materials exhibit in one way or another an ability to allow material to be removed from its surface, and particularly a fibrous web, thereby enhancing the release properties of the release layer 14.

Preferably, the reinforcing layer 18 comprises machine direction (MD) yarns 20 that run in the longitudinal direction L of the transfer belt 10. Cross machine direction (CMD) yarns 22 are interwoven and embedded in the polymeric foam to provide sufficient structural integrity. The CMD yarns extend generally at right angles to the MD yarns. The reinforcing layer 18 may be woven, non-woven knitted, glued, textile or non-textile. It may also be in the form of a membrane layer. The yarns 20 and 22 may be formed from aramid, glass fiber or other materials having flexibility and strength.

The polymer foam 16 may be selected from the group consisting of silicones, polyurethanes and polyamides. Preferably, the thickness t of the release layer 14 is between 1% and 95% of the thickness of the thickness T of the transfer belt 10. This ensures that the release layer 14 functions primarily as a release layer and does not contribute significantly to the structural integrity of the overall transfer belt 10. The release layer 14 penetrates the substrate 12 to a level from about 5% to 80% of the release layer thickness t so as to provide stable support for the release layer 14 by the substrate 12 and to prevent delamination.

The face of the belt that is opposite to the release layer 14 may have multiple grooves 24, only one of which is shown. Alternatively, the face may have a plurality of blind drilled or formed holes 26, only one of which is shown. These are placed in the belt to avoid slippage between the belt 10 and any rolls the belt comes in contact with.

The combination of the release layer with its superior properties of having flexibility and proper release of a fibrous web and the supporting substrate 12 with its superior structural characteristics provide a significant overall improvement in the performance of a transfer belt. The result of this structure is a greatly increased performance of a transfer belt.

While this invention has been described with respect to at least one embodiment, the present invention can be further modified within the spirit and scope of this disclosure. This application is therefore intended to cover any variations, uses, or adaptations of the invention using its general principles. Further, this application is intended to cover such departures from the present disclosure as come within known or customary practice in the art to which this invention pertains and which fall within the limits of the appended claims.

What is claimed is:

1. A transfer belt for carrying a web in a papermaking or similar machine, said transfer belt comprising:
a supporting substrate of a polymer foam and a reinforcement layer selected from the group consisting of aramid and glass fiber in one of a fabric and a layer; and
a release layer overlying and bonded to said supporting substrate, said release layer formed from a material promoting release of the web from said transfer belt.

2. A transfer belt as claimed in claim 1, wherein said release layer is formed from the group consisting of fluorinated polymers, polyolefin's, thermoplastic elastomer, thermoplastic urethane, and corona treated polymer.

3. A transfer belt as claimed in claim 1, wherein said release layer is formed from silicone.

4. A transfer belt as claimed in claim 1, wherein said release layer is formed from wax.

5. A transfer belt as claimed in claim 1, wherein said release layer is formed from a material exhibiting “Lotus Effect”.

6. A transfer belt as claimed in claim 1, wherein said release layer is formed from one of micro and nano structured layers.

7. A transfer belt as claimed in claim 1, wherein said release layer is covered with oil.

8. A transfer belt as claimed in claim 1, wherein said release layer penetrates said supporting substrate.

9. A transfer belt as claimed in claim 1, wherein the polymer foam in said substrate is formed from a polyurethane foam.

10. A transfer belt as claimed in claim 9, wherein said release layer penetrates said supporting substrate.

11. A transfer belt as claimed in claim 1, wherein the surface of said substrate opposite the release layer is provided with grooves.

12. A transfer belt as claimed in claim 1, wherein the reinforcement layer is in a fabric form and has yarns extending in the machine direction (MD) interwoven with yarns extending in the cross machine direction (CMD).

13. A transfer belt as claimed in claim 12, wherein said yarns are formed from the group consisting of glass fiber, aramid and polymers.

14. A transfer belt as claimed in claim 1, wherein said polymer foam is selected from the group consisting of silicones, Polyurethanes and Polyamides.

15. A transfer belt as claimed in claim 1, wherein the thickness of said release layer is between about 1% and about 95% of the transfer belt thickness (T).

16. A transfer belt as claimed in claim 1, wherein said release layer penetrates the substrate to a level from about 5% to about 80% of the release layer thickness (t).

17. A transfer belt as claimed in claim 1, wherein said reinforcing layer is selected from the group consisting of woven, non-woven knitted, glued, textile and non-textile.

18. A transfer belt as claimed in claim 1, wherein said supporting substrate has grooves in its surface that is opposite to said release layer.

19. A transfer belt as claimed in claim 1, wherein said supporting substrate has blind formed holes in its surface that is opposite to said release layer.
